(19) United States
(12) Patent Application Publication
(10) Pub. No.: US 2006/0136946 A1
(43) Pub. Date: Jun. 22, 2006

(54) Multiple-disk optical disk drive

(76) Inventor: Jui-Chiang Lin, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/068,789

(22) Filed: Mar. 2, 2005

(30) Foreign Application Priority Data
Dec. 17, 2004 (TW) 93139520

(51) Int. Cl. G11B 17/04

(52) U.S. Cl. 720/619

(57) ABSTRACT

The present invention discloses a multiple-disk optical disk drive that has a case, and a disk magazine and a disc reproducing module in the case, and the disk reproducing module includes a vertical transmission mechanism, a disk ejecting mechanism, and a pickup head. The disc reproducing module can move vertically up and down with respect to the disk magazine to eject a disk tray in the disk magazine. The disk magazine inserts into the case from the short side of the case. According to the present invention, it can effectively reduce the operating panel, enhance the convenience of use and the artistic look and sophistication of the product, lower the cost, and quickly and easily produce the optical disk drive in mass quantity.

### FIELD OF THE INVENTION

The present invention generally relates to a multiple-disk optical disk drive, and more particularly to a multiple-disk optical disk drive having a disk magazine being loaded into the optical disk drive from short side.

### BACKGROUND OF THE INVENTION

There are various different designs of the structure and configuration of a disk changer mechanism for traditional optical disk drives. The present invention specially aims at one of the designs as depicted in FIGS. 3 and 4 for the research and development of converting a transversal inserting disk magazine structure as shown in FIG. 4 into a vertical inserting disk magazine structure without changing the original transmission mechanism so as to achieve the objectives of reducing the size of the operating panel and producing the optical disk drive quickly in a mass production.

In the research and development of the present invention, a detailed prior art search was made to investigate related prior arts; and the R.O.C. Patent Publication No. 299063 (as depicted in FIG. 1) and the R.O.C. Patent Publication No.388534 (as depicted in FIG. 2) were found to be the related prior arts of the present invention. With careful comparisons and analyses, the basic structure of the overall transmission of these prior arts is very different from that of the present invention. These prior arts are not covered in the desired objects of the research and development of the present invention.

To make it easier to understand the aforementioned facts, the structure of these prior arts is analyzed as follows:

Firstly, please refer to FIG. 1 for the R.O.C. Patent Publication No. 299063. The structure in FIG. 1 includes a pickup head module 50, a disk selector 51, a disk magazine stand 52, a disk magazine 53, a plurality of disk trays 54, a first transmission mechanism 55 for driving the disk trays 54 in the disk magazine, a movable sliding stand 56 having a plurality of guide grooves for controlling the vertical movements of the pickup head module 50 and the disk selector 51, a bottom base 57 and a second transmission mechanism 58 for driving the sliding stand 56 to move reciprocally; wherein the method for ejecting the disk tray 54 according to this prior art is to build a serrated rack 540 on a lateral side of each of the disk trays 54 and engage an output gear wheel 550 of the first transmission mechanism 55 and the serrated rack 540 of the disk tray 54, such that the first transmission mechanism 55 can drive the disk tray 54 to eject and retract. In the overall structural design of this prior art, the first and second transmission mechanisms 55, 58 are in a fixed position with respect to the disk magazine 53, and the first and second transmission mechanism 55, 58 are not integrally formed with the pickup head module 50. With the consideration of the space for moving the sliding stand 56 back and forth and moving the pickup head module 50 up and down, the second transmission mechanism 58 must be installed on the bottom base 57 in the direction facing the disk magazine 53, and thus the volume for installing the disk magazine 53 is restricted and must be reduced. As the volume for installing the disk magazine 53 is reduced, the number of installable disk trays 54 will be decreased. Therefore, the structure of this prior art is very different from that of the present invention, and the present invention further makes improvement over the prior art by providing a stable mechanism, a large volume for installing disk magazine, and an easy way for the mass production.

Secondly, please refer to FIG. 2 for the R.O.C. Patent Publication No. 388534. The internal stored disk magazine as shown in FIG. 2 includes a first transmission mechanism 61 installed onto a system frame 60, a pickup head module 62, a disk magazine 63 a guide groove 600 disposed on both sides of the system frame 60 and a guide board 64 that is driven by the first transmission mechanism 61 to move reciprocally to the front and rear, a second transmission mechanism 65 installed on the system frame 60, a loader 66 that is controlled by the guide board 64 to move vertically up and down, a tray loader 67 and a tray 68 being installed onto the loader 66, such that the loader 66, the tray loader 67 and the tray 68 constitute the mechanical module for loading and selecting an optical disk.

When such prior art is used, a user stores some optical disks into the internal disk magazine 63 through the loader 66, and the loader 66 selects an optical disk from the internal disk magazine 63. The overall structural design of this prior art requires users to load the optical disks one by one, which is very inconvenient to users. Furthermore, the first transmission mechanism 61 and the pickup head module 62 are mounted onto the system frame 60 at the same time, the internal stored disk magazine 63 must be installed above the first transmission mechanism 61 and thus greatly increasing the volume of the whole optical disk drive. It is necessary to reduce the volume of the internal stored disk magazine in order to reduce the volume of the optical disk drive. As a result, the volume for installing the disk magazine becomes smaller and the number of optical disks that can be accommodated is decreased. Furthermore, the guide boards 64 disposed on both sides of the system frame 60 are movable components, and thus it is unable to install a damping device or a spring between the system frame 60 and the housing for the suspension purpose, which causes interferences. Therefore, this prior art cannot provide a mechanical model with a suspension shockproof effect, and the life of use for the optical disk drive system will be adversely affected. Obviously, the structure of this prior art is also very different from that of the present invention. The present invention has improvements over the prior art and allows user to load several optical disks at a time, makes its application much easier for users, and reduces the volume of the optical disk drive for accommodating the disk magazine. The present invention also features a shockproof design, an elongated life of use for the system, and an easy manufacturing process for a mass production.

Further, the U.S. Pat. No. 5,384,760 issued to Sony Company (Japan) also installs a disk magazine accommodating a plurality of trays onto a base by an elevator arm, and uses a motive force mechanism including a motor, a toothed wheel set and a cam to drive a disk magazine to move vertically up and down, and a pickup head module is also mounted onto the base. This prior art also relates to an internal stored disk magazine, and a plurality of guide shafts with the quantity equal to that of the trays of the disk magazine disposed on a side of the magazine proximate to the base, and each guide shaft has a slide base, and each slide base is hooked to a corresponding tray corner for ejecting the tray to select a desired optical disk.

The research and development plan of the present invention was processed with a comprehensive plan and its flow chart is described as follows:

1. Research and Development Motive: The motive is to solve the current problem of the prior-art models having an excessively large operating panel, and take the integrity and artistic feature of the overall stylish design of the product into consideration.

2. Main Object of Research and Development: The main object is to minimize costs.

3. Patent Infringement Assessment: The assessment aims at the purpose of not infringing other's patents or minimizing royalty fees for patent licensing.

4. Search for Model: The search aims at finding a mainstream model from various different models.

5. Evaluate mechanical problems: The evaluation includes the operation of components in coordination, the mechanical interference, and the level of difficulty of installing and designing other mechanical structures.

To make it easier to understand the model according to the desired research and development and the shortcomings of the current model, its mechanical structure is described with FIGS. 3 and 4. The structure includes a control circuit module (not shown in the figures); a housing 70 having an opening 71 disposed on one half of a long side for inserting the disk magazine 80; a system base 72 having a rectangular assembling area 73, and its assembling area is divided into a disk magazine area 730 and a disk reproducing area 731; a long guide track 720 disposed at the bottom of the disk magazine area 730 at the base 72, and the axial direction of the long guide track 720 is extended in the direction parallel to a short side of the rectangular assembling area 73; a disk magazine 80 being inserted from the opening 71 of the housing 70 and installed in the disk magazine area 730 of the base 72, and one end of the disk magazine 80 forms a larger disk magazine opening 81, and the bottom has a long guide groove 82 for containing the guide track 720 of the base 72, and the disk magazine 80 accommodates a plurality of disk trays 83 disposed from the top to the bottom inside the disk magazine 80, and each of said plurality of disk trays 83 is projected from an end corner having a hooked section 84 at the opening 81 of the disk magazine 80. The long guide groove 82 of the disk magazine 80 is parallel to the short side of the assembling area 73. A pair of sidewall panels 74 is disposed on two opposite sidewall panels 74 of the base 72, and each sidewall panel 74 has an aslant guide groove 740 slantingly extended from top to bottom; and a transverse 75 is installed in the transverse area 731 of the base 72 for moving the whole structure vertically up and down. The transverse 75 further comprises an optical pickup head module (not shown in the figure), a disk ejecting mechanism 76 for driving a sliding base 77 having a hooking section 770 corresponding to a hooked section 84 of the tray 83, and a vertical transmission mechanism 78 for driving the transverse 75 to move vertically up and down, and the vertical transmission mechanism 78 drives two sliding members 79, and a guide pillar 790 is protruded outwardly from each of the pair of the sliding members 79 and moves along the aslant guide groove 740 of the sidewall panel 74 and further drives the transverse 75 to move up and down. In the disk changer mechanism as shown in FIGS. 3 and 4, the disk magazine 80 is inserted from the housing 70 and the long side of the base 72. In other words, the long side must face outward so as to facilitate users to remove the disk magazine 80 and change the optical disk in the disk magazine 80. However, the area on the long side is larger, and the area of the operating disk magazine 80 is increased, so that it requires a larger disposing space, particularly for the installation of an optical disk drive in a motor vehicle. Since the space of a motor vehicle generally provides a larger vertical depth and a smaller transversal depth; for example, if the optical disk drive is installed under the seat or in the trunk of a motor vehicle, the prior-art disk changer must be installed transversally under the seat or in the truck. If a fixing frame of the disk changer is installed, then the overall transversally extended width will be larger, which will cause an interface between the disk changer and the operating components under the seat, or will make the use of the trunk for storing baggage very inconvenient. Further, the prior-art model can only install the operating panel at the insert opening 71 of the disk magazine 80 on the long side of the housing 70, and the remained section of the long side is left unused. Therefore, such arrangement cannot give an artistic design for the whole operating panel with a minimum cost.

### SUMMARY OF THE INVENTION

To develop a competitive product for the market, the inventor of the present invention put up lots of efforts to develop the products in accordance with the present invention.

Therefore, it is a primary objective of the present invention to provide a disk changer mechanism that can effectively reduce the size of the operating panel, improve the convenience of use, enhance the artistic and sophisticated features of the product, lower the cost, and provide an easy and quick mass production.

The multiple-disk optical disk drive includes a case, a disk magazine, and a disk reproducing module. The case defines a long side and a short side and is divided into a disk magazine area and a disk reproducing area. The case has an opening disposed on the short side of the case, a slanted guide groove disposed on both side wall of the disk reproducing area, and a guide track disposed at the disk magazine area, wherein the guide track is parallel to the long side.

The disk magazine is inserted from the opening and installed in the disk magazine area. There is a plurality of disk trays disposed in the disk magazine, and each of the disk trays has a hooked section. The disk magazine has a guide groove being parallel to the long side and engaged with the guide track.

The disk reproducing module is installed in the disk reproducing area of the case and moved vertically up and down along the slanted guide groove. The disk reproducing module has an ejecting mechanism, and the ejecting mechanism includes a sliding base reciprocally moving in the direction parallel to the long side. A hooking section is protruded from the sliding base being hooked to the hooked section for selecting an optical disk and ejecting the disk tray from the disk magazine, so that the disk reproducing module reads the data recorded on the optical disk placed on the disk tray.

When the disk reproducing module is moved to the lowest point of the slanted guide groove, the hooking section of the sliding base is lower than the hooked section of the disk tray at the bottom of the disk magazine.

### BRIEF DESCRIPTION OF THE DRAWINGS

FIG. 1 is a schematic view of a disk ejecting mechanism of a first prior art;

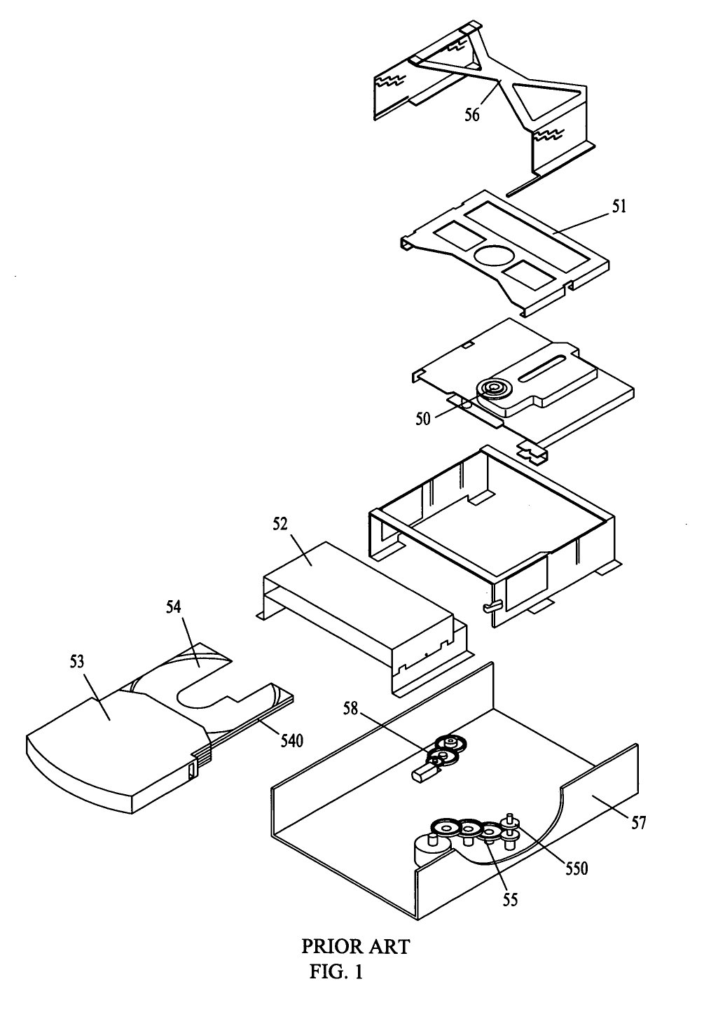

FIG. 2 is a schematic view of a disk ejecting mechanism of a second prior art;

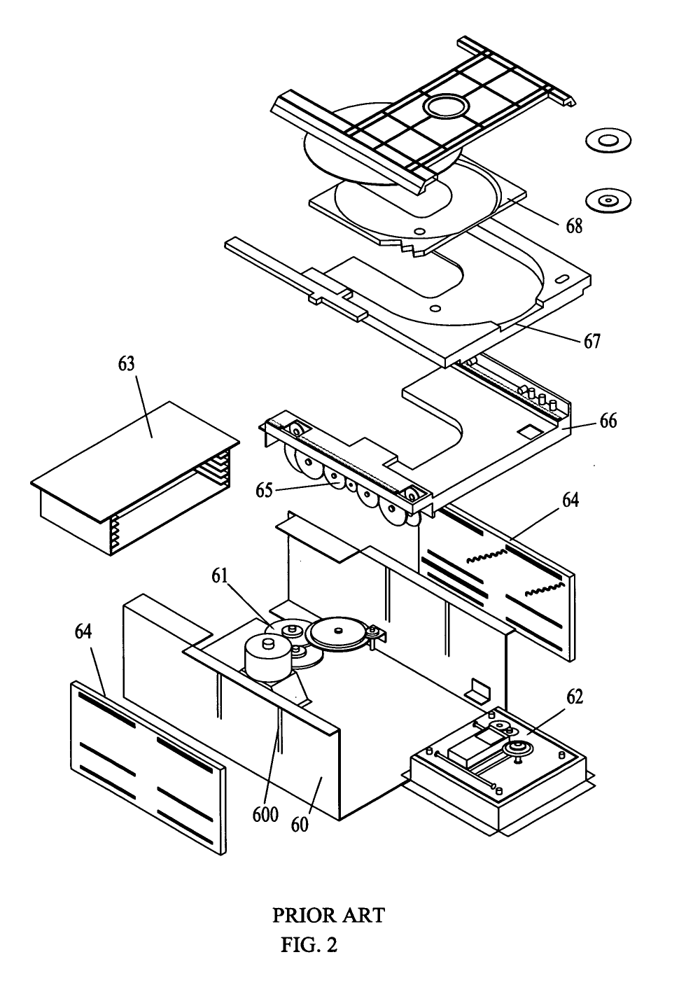

FIG. 3 is a schematic view of a disk ejecting mechanism of a third prior art;

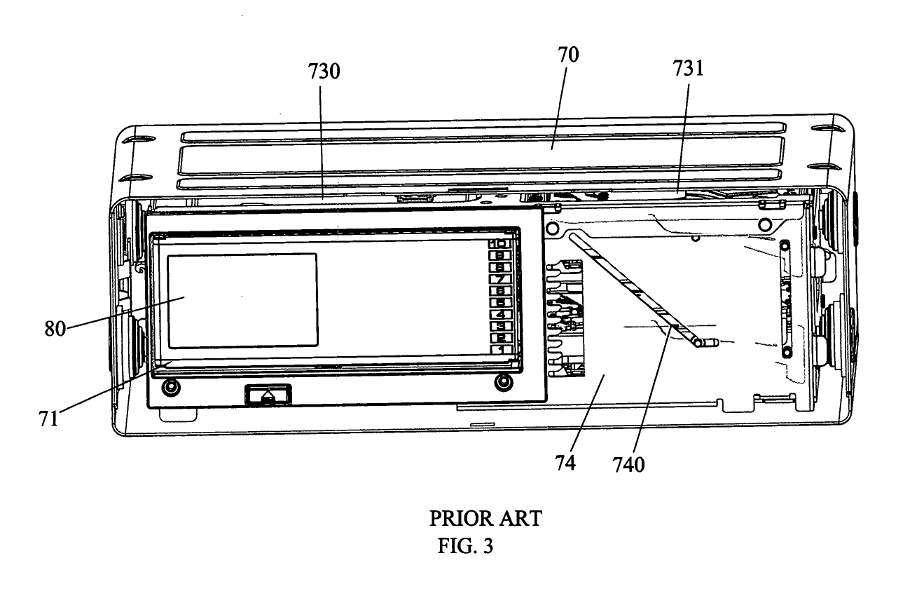

FIG. 4 is a schematic view of a disk ejecting mechanism removing the case according to the third prior art;

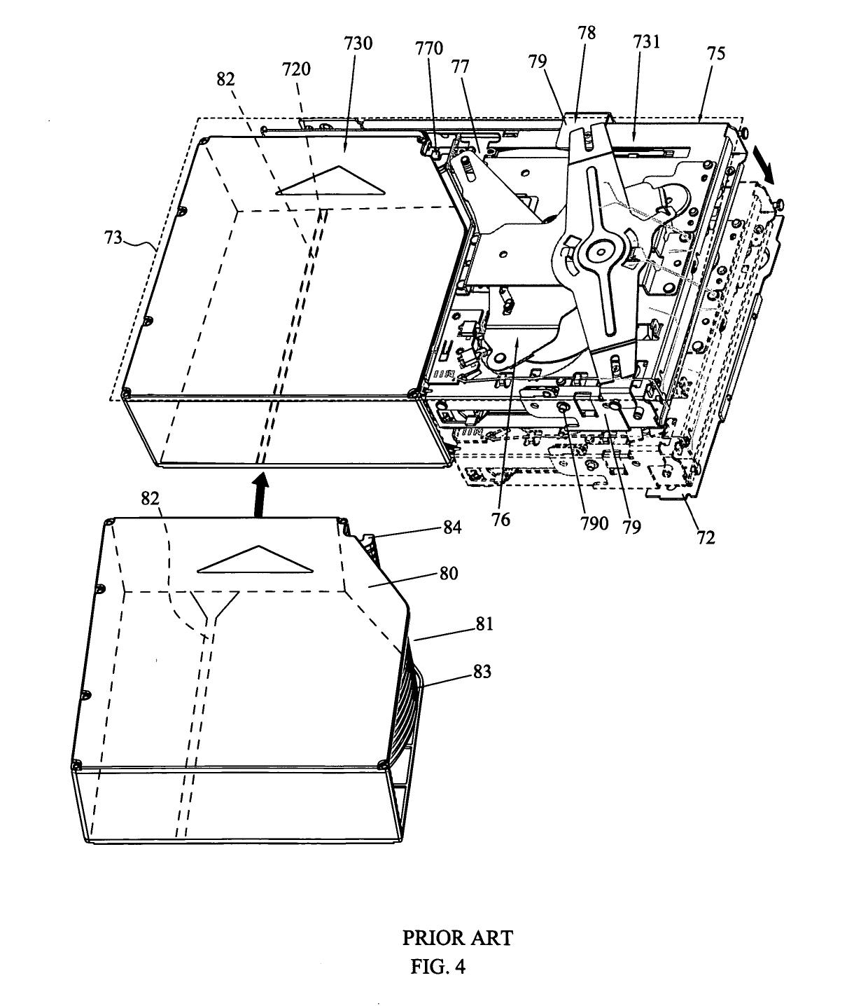

FIG. 5 is a schematic perspective view of the present invention;

FIG. 6 is a schematic view of removing a case of the present invention;

FIG. 7 is a schematic view of removing the upper section of a disk magazine according to the present invention;

FIG. 8 is a bottom view of a disk reproducing module of the present invention;

FIG. 9 is a schematic view of the relation between a disk magazine and a case according to the present invention;

FIG. 10 is a schematic view of a damping device disposed between a housing and a case and an operating panel according to the present invention; and

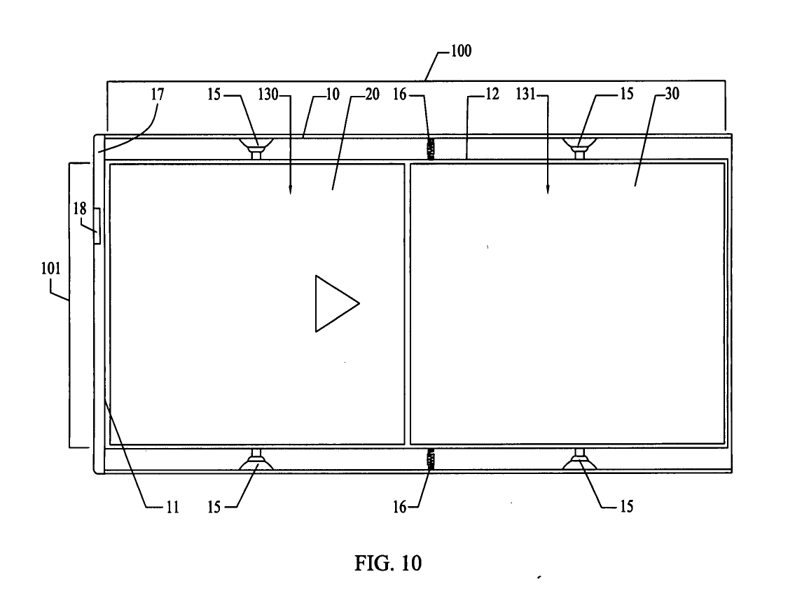

FIG. 11 is a schematic view of a sliding base of an ejecting mechanism being lower than a tray at the bottom of a disk magazine when the ejecting mechanism is disposed at the bottom end of a slanted guide groove according to the present invention.

### DETAILED DESCRIPTION OF THE PREFERRED EMBODIMENTS

To make it easier to understand the objective of the invention, its structure, innovative features, and performances, a preferred embodiment together with the attached drawings for the detailed description of the invention is described bellow.

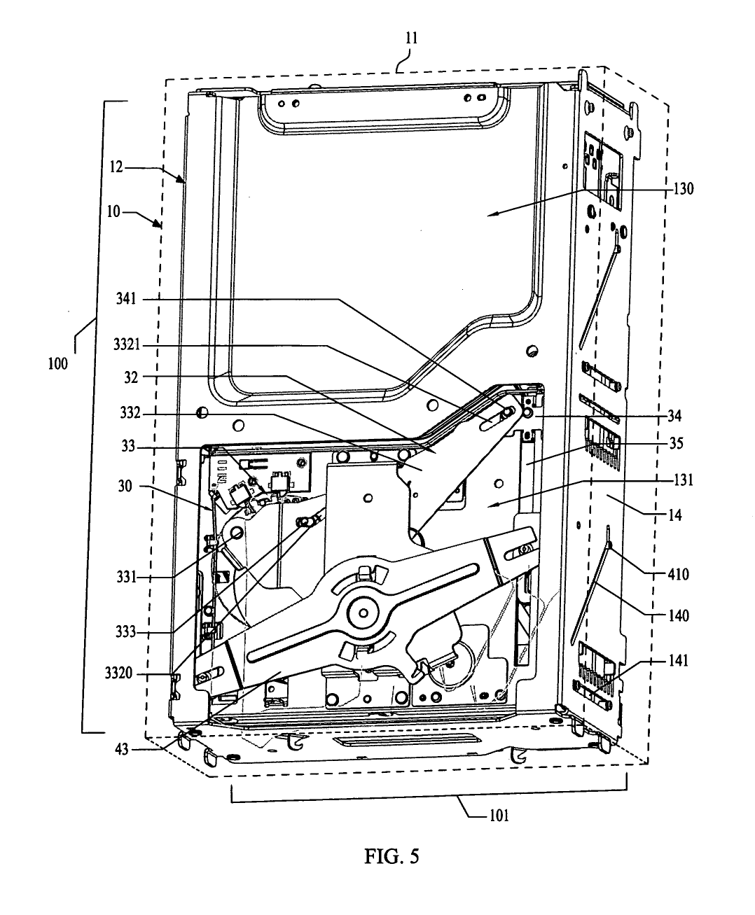

Please refer to FIGS. 5 to 9, the preferred embodiment of the present invention is shown. The multiple-disk optical disk drive includes a case 12, a disk magazine 20, and a disk reproducing module 30.

The case 12 defines a long side 100 and a short side 101 and divides into a disk magazine area 130 and a disk reproducing area 131. The case 12 has an opening 11 disposed at the short side 101, a slanted guide groove 140 disposed on both side walls 14 of the transverse area 131, and a guide track 120 disposed at the bottom of the disk magazine area 130 of the case 12, wherein the guide track 120 is parallel to the long side 100. The disk magazine 20 is inserted from the opening 11 and installed in the disk magazine area 130, and has a plurality of disk trays 21 disposed in the disk magazine 20, wherein the bottom of the disk magazine 20 has a guide groove 22 parallel to the long side 100. When the disk magazine is loading into the case 12, the guide groove 22 is passing alone the guide track 120 and engaging with the guide track 120.

The disk reproducing module 30 is installed in the disk reproducing area 131 of the case 12, and moved vertically up and down along the slanted guide groove 140 of the case 12 for selecting an optical disk and ejecting the selected disk tray 21 from the disk magazine 20 to read the data recorded on the optical disk placed on the selected disk tray 21. When the disk reproducing module 30 is moved to the lowest position of the slanted guide groove 140, the position of the disk reproducing module 30 is lower than the position of the bottom of the disk tray 12 in the disk magazine 21.

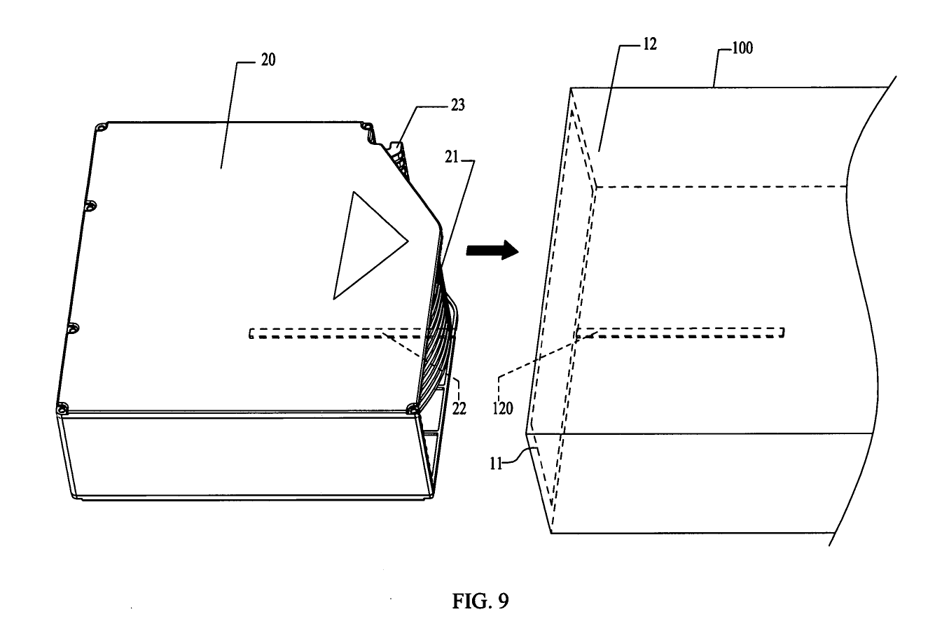

Please refer to FIG. 9 for a preferred embodiment of the present invention, which further includes a housing 10. The housing 10 also has an aperture 11 disposed at a position corresponding to the opening of the case 12 for facilitating the insertion of the disk magazine 20 from the aperture of the housing and the opening 11 of the case 12 and the installation to the disk magazine area 130 of the case 12.

In the preferred embodiment of the present invention, a damping device 15 is installed at a long side 100 between the housing 10 and the case 12, such that the case 12 is suspended and installed in the housing 10 so as to provide a shockproof effect for the whole case 12 and improve the life of use of the optical disk drive. The retractable spring 16 is also installed at the long side between the housing 10 and the case 12, such that the case 12 is suspended and installed in the housing 10. The control panel 17 is covered onto the aperture of the housing 10, and the control panel 17 has a control keypad 18, such that the end surface of the whole housing 10 is covered by an artistic control panel 17 to greatly improve the sophisticated and artistic look of the optical disk drive.

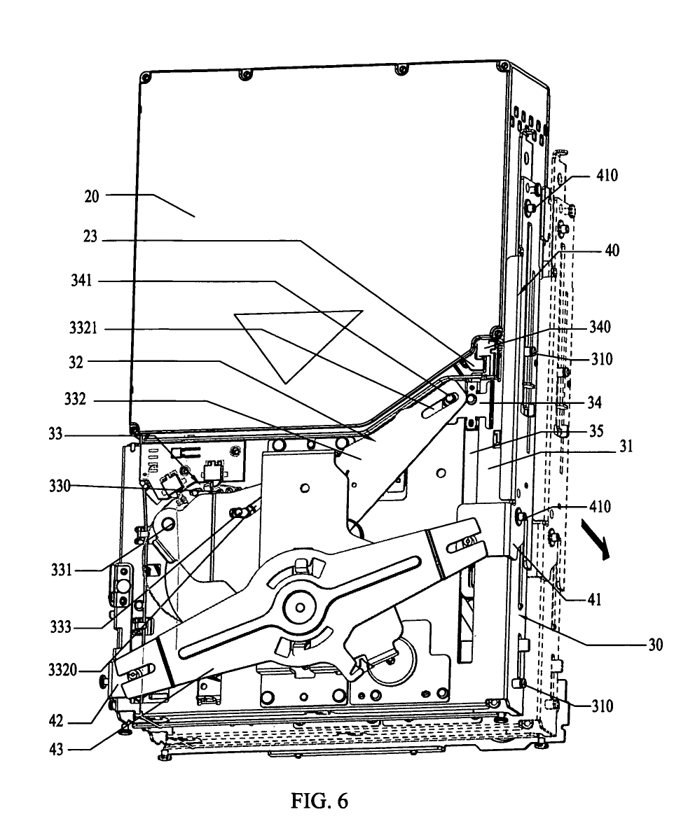

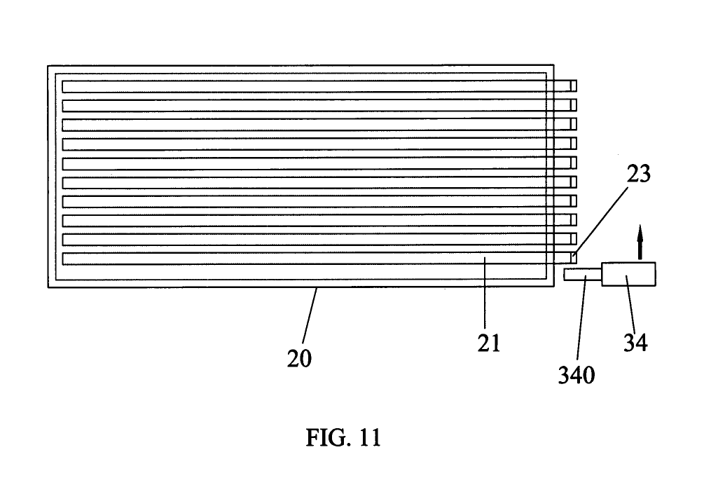

Please refer to FIG. 6 for the disk reproducing module 30 according to the preferred embodiment of the present invention that includes a base 31, a pickup head module (not shown in the figure), and ejecting mechanism 32. The disk pickup head module (not shown in the figure) is coupled on the base 31 for reading or writing data on the optical disk on the disk tray 21. The ejecting mechanism 32 is coupled on the base 31, and the ejecting mechanism 32 includes a sliding base 34 that moves reciprocally along the direction parallel to the long side 100 of the base 12 and the sliding base 34 has a hooking section 340 for hooking a hooked section 23 of the disk tray 21 in the disk magazine 20 so as to eject the disk tray 21 from the disk magazine 20, such that when the disk reproducing module 30 moves to the lowest point of the slanted guide groove 140, the hooking section 340 of the sliding base 34 is lower than the hooked section 23 of the disk tray 21 at the bottom of the disk magazine 20 (please also refer to FIG. 11).

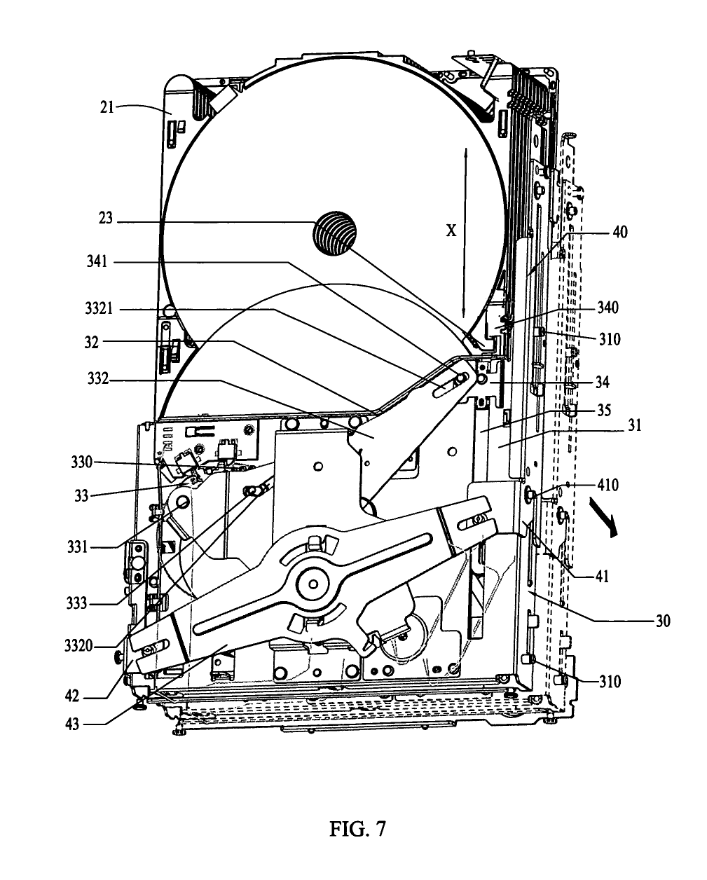

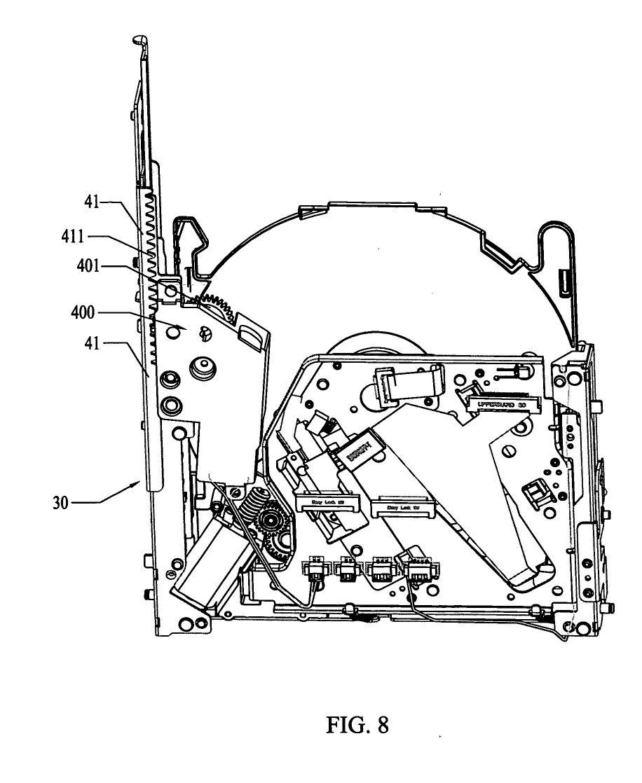

Please refer to FIG. 7 and FIG. 8, the disk reproducing module 30 of the present invention is shown. The disk reproducing module 30 further includes a vertical transmission mechanism 40. The vertical transmission mechanism 40 includes a drive means 400 and a pair of sliding members 41, 42 moving in the opposite direction with each other. An output end of the drive means 400 is a gear wheel 401, and a serrated rack 411 is installed at a lateral side of the sliding member 41, and the gear wheel 401 is engaged with the serrated rack 411 of the sliding member 41. The vertical transmission mechanism 40 drives the disk reproducing module 30 to move vertically up and down in the disk reproducing area 131. In a preferred embodiment of the present invention, a rotary rod 43 is pivotally coupled to the disk reproducing module 30, and both ends of the rotary rod 43 are coupled respectively with each of the sliding members 41, 42 to drive the sliding members 41, 42 to move in a direction opposite to each other. A guide pillar 410 is protruded from the sliding member 41, 42, and the guide pillar 410 is installed into the slanted guide groove 140. When the sliding member 41, 42 moves to drive the guide pillar 410 to move vertically up or down along the aslant guide groove 140, the whole disk reproducing module 30 is driven to move vertically up and down in the disk reproducing area 131 of the case 12.

With reference to FIG. 5, the ejecting mechanism 32 of the disk reproducing module 30 according to the preferred embodiment includes a protruded latch rod 333 being projected from an eccentric position of a large output gear disk 330 of the dynamic force set 33, and an axle 331 on the case 31 is pivotally coupled to a swing rod 332, and the swing rod 332 has a guide groove 3320 for latching the latch rod 333. The case 31 also includes a sliding track 35 parallel to the long side 100, and the sliding base 34 is installed on the sliding track 35 and can move along the sliding track 35. A protruded rod 341 is disposed on the sliding base 34 and latched to the swing rod 332 proximate to a long hole 3321 disposed at an end, such that when the large gear disk 330 rotates, the latch rod 33 on the large gear disc 330 drives the swing rod 332 to swing with the axle 331 as its center, such that the long hole 3321 of the swing rod 332 drives the protruded rod 341 and the sliding base 34 to move forward or backward along the sliding track 35 of the case 31.

In view of the foregoing analysis and design, the present invention at least has the following advantages:

1. The invention achieves the objective of effectively reducing the area of its operating panel to save the limited space of the operating interface, particularly for the installation in a motor vehicle. The multiple-disk optical disk drive in accordance with the present invention will not interfere with other operating components of the motor vehicle, and can effectively increase the storage space in a motor vehicle.

2. The invention features a small overall volume and a large capacity of the disk magazine.

3. The invention has a secure structure and can add a suspension shockproof device to elongate the life of use for the product.

4. The operating panel can be installed easily on the operating side at the short side of the housing to improve the integrity and artistic look of the overall design and greatly enhance the sophistication of the product.

5. The invention can effectively lower the cost and produce the products quickly in a mass production.

While the invention has been described by means of a specific embodiment, it is to be understood that the invention is not limited thereto and numerous modifications and variations could be made thereto by those skilled in the art without departing from the scope and spirit of the invention set forth in the claims.

What is claimed is:

1. A multiple-disk optical disk drive, comprising:
a case, defining a long side and a short side and divided into a disk magazine area and a disk reproducing area, said case having an opening disposed on said short side of said case, a slanted guide groove disposed on both side wall of said disk reproducing area, and a guide track disposed at said disk magazine area, wherein said guide track is parallel to said long side;
a disk magazine, being inserted from said opening and installed in said disk magazine area, and having a plurality of disk trays disposed in said disk magazine, wherein said disk magazine has a guide groove being parallel to said long side and engaged with said guide track, and each of said disk trays has a hooked section; and
a disk reproducing module, being installed in said disk reproducing area of said case, and moving vertically up and down along said slanted guide groove, said disk reproducing module having an ejecting mechanism, and said ejecting mechanism comprising a sliding base reciprocally moving in the direction parallel to said long side, and a hooking section protruded from said sliding base being hooked to said hooked section for selecting an optical disk and ejecting said disk tray from said disk magazine, and reading the data recorded on said optical disk placed on said disk tray,
wherein, when said disk reproducing module moves to the lowest point of said slanted guide groove, said hooking section of said sliding base is lower than said hooked section of said disk tray at the bottom of said disk magazine.

2. The multiple-disk optical disk drive as claimed in claim 1 further comprising a housing, and said case is installed in said housing, and said housing includes an aperture at a corresponding position with said opening of said case for installing said disk magazine in said disk magazine area.

3. The multiple-disk optical disk drive as claimed in claim 2 further comprising a damping device disposed at said long side between said housing and said case, such that said case is installed into said housing by a suspension method.

4. The multiple-disk optical disk drive as claimed in claim 2 further comprising a compression spring disposed at said long side between said housing and said case, such that said case is installed into said housing by a suspension method.

5. The multiple-disk optical disk drive as claimed in claim 1, wherein said disk reproducing module further comprises:
a base, wherein said ejecting mechanism is disposed thereon; and
a pickup head module, being coupled on said base for reading the data recorded on said optical disk on said disk tray.

6. The multiple-disk optical disk drive as claimed in claim 5, wherein said ejecting mechanism further comprises:
a protruded rod, disposed on said sliding base;
a drive means, having a large gear disc at its output end, and a latch rod disposed at an eccentric position of said large gear disc;
a swing rod, pivotally coupled to said base and having a guide groove and a straight hole, and said straight hole being disposed at the end of said swing rod, and said protruded rod passes and latches into said straight hole, and said latch rod passes and latches into said guide groove; and
a sliding track, being disposed on said base and parallel to said long side,
wherein, when said large gear disc rotates, said latch rod drives said swing rod to swing and said straight hole drives said protruded rod and said sliding base to move along said sliding track.

7. The multiple-disk optical disk drive as claimed in claim 5, wherein said disk reproducing module further comprises a vertical transmission mechanism, and said vertical transmission mechanism comprises a dynamic mechanism and a pair of sliding member moving in the direction opposite to each other, and said dynamic mechanism has a gear wheel at its output end, and said sliding member has a serrated rack at its lateral side, and said gear wheel is engaged with said serrated rack of said sliding member, thereby said transmission mechanism drive said transverse to move vertically up and down in said transverse area.

8. The multiple-disk optical disk drive as claimed in claim 7, wherein said vertical transmission mechanism comprises a rotary rod being pivotally coupled to said base, and both ends of said rotary rod are coupled to each of said pair of sliding member, such that when said rotary rod rotates, said pair of sliding members moves in the direction opposite to each other.

9. The multiple-disk optical disk drive as claimed in claim 2, wherein said housing comprises a control panel covering said aperture, and said control panel has a control keypad.
